(19) United States
(12) Patent Application Publication
(10) Pub. No.: US 2018/0290595 A1
(43) Pub. Date: Oct. 11, 2018

(54) VEHICLE SIDE MIRROR POSITIONING METHOD AND ASSEMBLY

(71) Applicant: Ford Global Technologies, LLC, Dearborn, MI (US)

(72) Inventor: Aed M. Dudar, Canton, MI (US)

(21) Appl. No.: 15/484,573

(22) Filed: Apr. 11, 2017

(51) Int. Cl. B60R 1/074; G06K 9/00; B60R 1/12; B60K 35/00; G01S 13/04

(52) U.S. Cl. CPC B60R 1/074; G06K 9/00805; B60R 1/12; B60K 35/00; G01S 13/04; B60R 2001/1253; B60K 2350/2047; B60R 2300/301; B60R 2300/8026; B60R 2300/8073; B60K 2350/924; B60K 2350/106; B60K 2350/2013; B60R 2300/105

(57) ABSTRACT

An exemplary mirror positioning method includes tilting a reflective portion of at least one side mirror outward and downward in response to a detection of an object moving outside a passenger cabin of a vehicle. The tilting is independent from a position of the object. Another exemplary mirror positioning method includes tilting a reflective portion of at least one side mirror fully outward and fully downward in response to a detection of an object moving outside a passenger cabin of a vehicle. An exemplary mirror positioning assembly includes a surveillance controller, and a side mirror with a reflective portion that is configured to automatically tilt outward and downward in response to a command from the surveillance controller. The command issued in response to a detection of an object moving outside a passenger cabin of a vehicle, the tilting independent from a position of the object.

### TECHNICAL FIELD

This disclosure relates generally to positioning a side mirror of a vehicle. In particular, the disclosure relates to automatically positioning a side mirror to increase a field of view for an occupant of the vehicle.

### BACKGROUND

A vehicle typically includes side mirrors to help occupants within a passenger compartment see areas behind and to the sides of the vehicle. The side mirrors are typically adjustable, and many side mirrors can tilt both vertically and horizontally. An occupant, for example, can actuate a switch to tilt the side mirrors.

The side mirrors of some vehicles fold inward toward the passenger compartment when the vehicle is parked. This helps to protect the side mirrors. Passing cars, for example, could clip and damage side mirrors of a parked vehicle if the mirrors are not folded inward.

An occupant within the passenger compartment may wish to view areas behind and to the side of the vehicle when the vehicle is parked. For example, an officer within the passenger compartments of a law enforcement vehicle may wish to view these areas to prevent a person from moving toward the law enforcement vehicle without being detected by the officer.

### SUMMARY

A mirror positioning method according to an exemplary aspect of the present disclosure includes, among other things, tilting a reflective portion of a side mirror outward and downward in response to a detection of an object moving outside a passenger compartment of a vehicle. The tilting is independent from a position of the object.

In a further non-limiting embodiment of the foregoing method, the tilting occurs automatically.

In a further non-limiting embodiment of any of the foregoing methods, the tilting includes tilting the reflective portion fully outward and fully downward.

A further non-limiting embodiment of any of the foregoing methods includes automatically deploying the side mirror from a folded position to an unfolded position in response to the detection.

A further non-limiting embodiment of any of the foregoing methods includes automatically extending the side mirror in response to the detection.

A further non-limiting embodiment of any of the foregoing methods includes automatically providing an image from a camera in response to the detection.

In a further non-limiting embodiment of any of the foregoing methods, the camera is at least partially housed within the side mirror.

In a further non-limiting embodiment of any of the foregoing methods, the at least one side mirror is a driver side mirror.

In a further non-limiting embodiment of any of the foregoing methods, the at least one side mirror includes both a driver side mirror and a passenger side mirror.

In a further non-limiting embodiment of any of the foregoing methods, the vehicle is parked during the positioning.

In a further non-limiting embodiment of any of the foregoing methods, the vehicle is a law enforcement vehicle.

A mirror positioning method according to another exemplary aspect of the present disclosure includes tilting a reflective portion of a side mirror fully outward and fully downward in response to a detection of an object moving outside a passenger cabin of a vehicle.

In a further non-limiting embodiment of the foregoing method, the tilting is independent from a position of the object.

A mirror positioning assembly according to yet another exemplary aspect of the present disclosure includes, among other things, a surveillance controller, and a side mirror with a reflective portion configured to automatically tilt outward and downward in response to a command from the surveillance controller. The command is issued in response to a detection of an object moving outside a passenger cabin of a vehicle. The tilting is independent from a position of the object.

In a further non-limiting embodiment of the foregoing assembly, the side mirror is a driver side mirror.

In a further non-limiting embodiment of any of the foregoing assemblies, the side mirror moves to a fully outward and fully downward position in response to the command.

A further non-limiting embodiment of any of the foregoing assemblies includes a sensor configured to detect the object.

In a further non-limiting embodiment of any of the foregoing assemblies, the sensor includes a camera.

In a further non-limiting embodiment of any of the foregoing assemblies, the sensor includes a radar sensor.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a top view of a vehicle that is parked with the side mirrors of the vehicle in a folded position.

FIG. 2 illustrates the steps in an example method of positioning the side mirrors of the vehicle of FIG. 1.

FIG. 3 illustrates the vehicle of FIG. 1 with the side mirrors in an unfolded position.

FIG. 4 illustrates a close-up view of a side mirror from the driver side of the vehicle of FIG. 3.

FIG. 5 illustrates a section view taken at line 5-5 in FIG. 4.

FIG. 6 illustrates a section view taken at line 6-6 in FIG. 4.

FIG. 7 illustrates a mirror according to another exemplary embodiment of the present disclosure in a retracted position.

FIG. 8 illustrates the side mirror of FIG. 7 in an extended position.

FIG. 9 illustrates a side mirror according to yet another exemplary embodiment of the present disclosure.

### DETAILED DESCRIPTION

This disclosure relates to automatically positioning a side mirror of a vehicle. The positioning can be in response to a sensor detecting an object that is moving near the vehicle, particularly an object behind the side mirror. The positioning is particularly useful for a law enforcement vehicle where occupants within the passenger compartment want to quickly view their surroundings if an object that is moving is detected near the law enforcement vehicle.

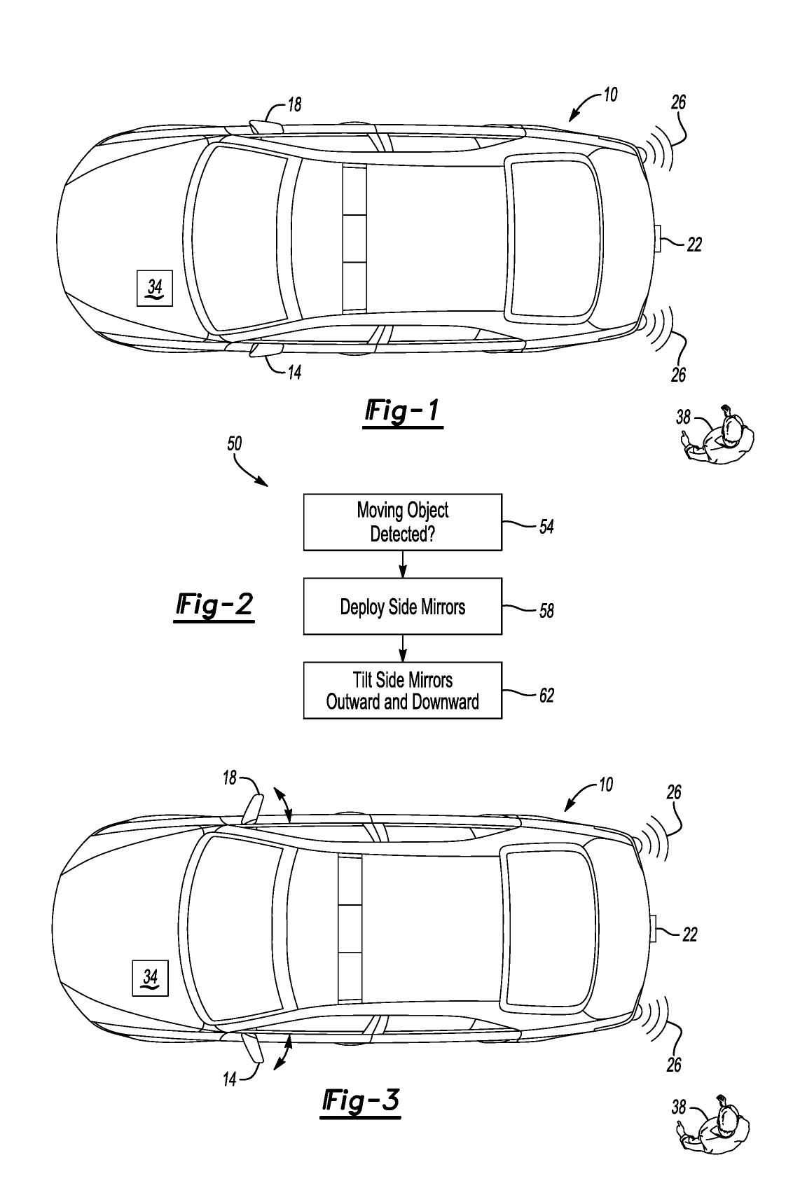

Referring to FIG. 1, an example vehicle 10 includes a side mirror 14 and a side mirror 18. The side mirror 14 is on a driver side of the vehicle 10. The side mirror 18 is on the passenger side of the vehicle 10.

The vehicle 10 is occupied and is parked along, for example, a side of a road. The gearshift is in park and the vehicle 10 could be keyed off, keyed on, in an accessory key mode, etc. The side mirrors 14, 18 are folded inward because the vehicle 10 is parked. Folding the side mirrors 14, 18 reduces a chance that the side mirrors 14, 18 will be clipped by a passing car.

In this exemplary non-limiting embodiment, the vehicle 10 is a law enforcement vehicle, such as a Police Interceptor, and a passenger compartment of the vehicle 10 is occupied by a law enforcement officer.

The vehicle 10 includes a rearview camera 22 and radar sensors 26 that are operatively connected to a surveillance controller 34. The rearview camera 22 and the radar sensors 26 act as sensors to help identify objects about the vehicle 10, both moving and stationary. In some examples, the rearview camera 22 captures an image that is displayed on a screen within the passenger compartment of the vehicle 10. In some examples, the radar sensors are part of a blind spot information system (BLIS). The surveillance controller 34 can use information from the camera 22, the radar sensors 26, or both to detect an object moving near the vehicle, such as a person 38. Other sensors could also be used, including sonar, LiDAR, etc.

The occupant of the vehicle 10, here the law enforcement officer, is typically facing forward, and the person 38 is behind the vehicle 10 outside the occupant's field of view. Thus, the occupant would need to turn to view the person 38, or use a mirror to view a reflection of the person 38.

The surveillance controller 34 can execute a program that continually interprets information from the camera 22 and radar sensors 26 to detect when an object is moving near the vehicle. An individual having skill in this art and the benefit of this disclosure would understand how to use the rearview camera 22 and the surveillance controller 34, or the radar sensors 26 and the surveillance controller 34 to detect an object moving near the vehicle 10. Of course, the surveillance controller 34 could respond to information from other sources instead of, or in addition to, the camera 22 and the radar sensors 26, and use the information from the other sources to detect an object moving near the vehicle 10.

If the surveillance controller 34 detects an object moving near the vehicle 10, especially an object that is moving outside the occupant's field of view, the surveillance controller 34 can automatically initiate actions to provide the occupant with information about the object.

In this exemplary embodiment, with reference to FIG. 2, the example surveillance controller 34 automatically executes a mirror positioning method 50 in response to information gathered from the camera 22, radar sensors 26, or both. The occupant may initiate the method 50 by actuating a switch or interacting with a human machine interface, for example.

The mirror positioning method 50 generally includes a first step 54 where the side mirror positioning method 50 recognizes that an object moving near the vehicle 10 and outside the occupant's field of view has been detected. Until an object is detected moving near the vehicle 10, the method 50 loops within the step 54.

Next, at a step 58, the method 50 deploys the side mirrors 14, 18 from the folded position of FIG. 1 to the deployed position of FIG. 3. Deploying the side mirrors 14, 18 provides the occupant within the passenger compartment of the vehicle 10 with a reflected view of areas aft of the side mirrors 14, 18.

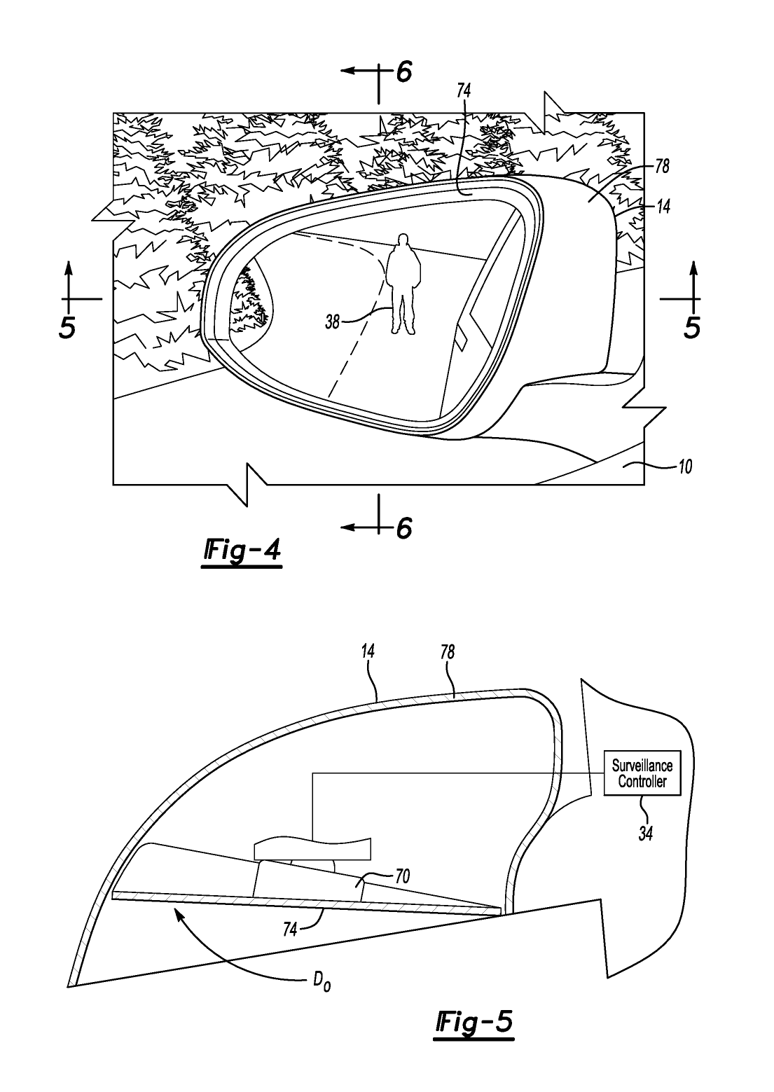

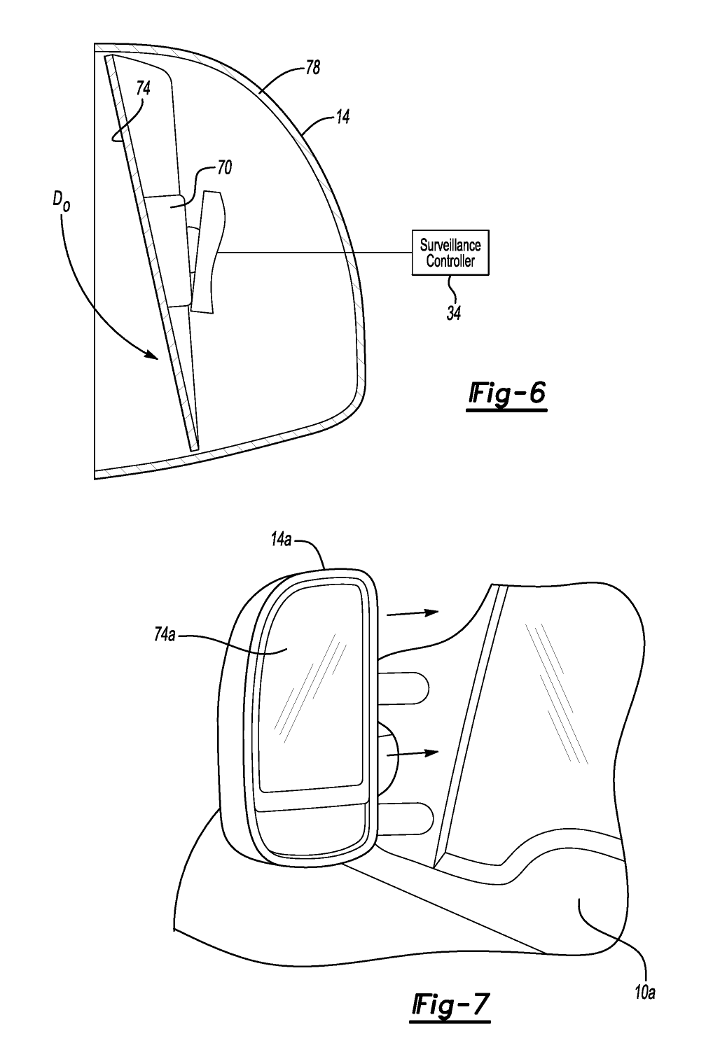

Referring now to FIGS. 4-6 with continuing reference to FIGS. 2-3, the method 50, at a step 62, uses an actuator 70 to tilt a reflective portion 74 of the side mirror 14 fully outward in a direction D_{O} and fully downward in a direction D_{D}. Generally, the actuator 70 manipulates the reflective portion 74 that is held within a housing 78 of the side mirror 14. The actuator 70 positions the reflective portion 74 in response to commands from the surveillance controller 34.

A corresponding actuator is held within the side mirror 18. The actuator within the side mirror 18 can tilt a reflective portion of the side mirror 18 fully outward and fully downward in response to commands from the surveillance controller 34.

Some or all of the tilting could occur as the side mirrors 14, 18 are unfolded to reduce a time required to tilt and fold. Alternatively, the tilting could occur after the side mirrors 14, 18 are deployed.

Tilting the side mirrors 14, 18 fully outward ensures that a horizontal field of view reflected to the occupant from the side mirror 14 extends outboard away from the vehicle 10 as far as possible, and that a horizontal field of view reflected to the occupant from the side mirror 18 extends outboard away from the vehicle 10 as far as possible. The endpoints of the horizontal field of view reflected to the occupant from the side mirrors 14, 18 are thus effectively expanded outward as far as possible. This permits the occupant to view the area most likely to include an object posing a threat to the occupant of the vehicle 10.

That is, if the person 38 wanted to harm the occupant of the vehicle 10, the person 38 would not likely approach the vehicle 10 near the midline of the vehicle 10 (near the camera 22). Instead, the person 38 would attempt to approach the doors of the vehicle 10. Tilting the reflective portion of the side mirror 14 fully outboard would capture most of the movements of the person 38 approaching the doors. If the side mirror 14 were instead tilted inboard, some of the area outboard the vehicle 10 would not be reflected to the occupant.

If the person 38 were instead near the camera 22, the camera 22 could show the image of the person 38 on a display within the vehicle 10. The camera 22 for example could display a LiDAR image of the person 38 on a human machine interface within the vehicle 10. Additionally, the radar sensors 26 may detect a person near the camera 22. Tilting the reflective portion 74 of the side mirror 14 fully outboard (and downward) reveals areas to the occupant that the camera 22, and potentially the radar sensors 26, do not reach.

Tilting the side mirrors 14, 18 fully downward ensures that a vertical field of view reflected to the occupant from the side mirrors, 14, 18 is focused on the areas most likely to contain a threat to the occupant. If, for example, the person 38 were crawling on the ground in an attempt to approach the vehicle 10 without being detected by the occupant, tilting the side mirrors 14, 18 fully downward would effectively maximize the ground that is viewable to the occupant. The occupant is thus able to view the area most likely to include an object (e.g., the person 38) potentially posing a threat to the occupant of the vehicle 10. The downward tilting could also reveal that the object is relatively harmless, such as if the object is a squirrel or a ball.

As known, some law enforcement vehicles can selectively enter a surveillance mode when parked. The surveillance mode automatically initiates an alarm, rolls up windows, and locks doors in response to, for example, a movement detected behind the law enforcement vehicle. The surveillance mode protects the occupants of the law enforcement vehicle. The occupant may selectively enter or exit the surveillance mode by actuating a switch or interacting with a human machine interface, for example.

The method 50 could be incorporated into such a surveillance mode. That is, when the vehicle 10 is parked and occupied, and an object is detected moving near the vehicle 10. In this example automatically the surveillance controller 34 initiates the alarm, the rolls up the window, and executes the side mirror positioning method 50.

The modified surveillance mode alerts the occupant to the moving object, provides some protection (by rolling up the windows), and provides the occupant with an increased field of view around the vehicle 10. The occupant can then scan areas around the vehicle 10 to determine if the object that is moving near the vehicle 10 presents a threat to the occupant.

By moving the reflective portion 74 of the side mirror 14 fully outward and downward, and correspondingly moving a mirrored portion of the side mirror 18, the field of view behind the vehicle is effectively maximized for the officer. That is, the visual envelope is maximized.

With the maximized field of view, the officer can quickly ascertain whether an intruder is approaching the vehicle 10 from behind the vehicle 10, or whether the moving object is something other than an intruder.

The method 50 is executed automatically in response to the detection of a moving object. The method 50 can be executed on a processor stored within the surveillance controller 34. It should be understood that the surveillance controller 34 could be part of an overall vehicle control module, such as a vehicle system controller (VSC), or could alternatively be a stand-alone controller separate from the VSC.

The surveillance controller 34 can be programmed with executable instructions for interfacing with and operating the various components of the vehicle 10. Various programs could be stored within a memory portion of the surveillance controller 34 and executed on a processing unit of the surveillance controller 34. That is, the surveillance controller 34 can include non-transitory memory and a processing unit for executing the various control strategies and modes of the vehicle system.

In this example, the side mirrors 14, 18 both deploy and then tilt outward and downward in response to a command from the surveillance controller 34. In other examples, only the side mirror 14, or only the side mirror 18, is automatically deployed and tilted outward and downward. For example, it the object is detected moving toward a driver side of vehicle 10, the side mirror 14 could be deployed and tilted outward and downward rather than both the side mirrors, 14, 18.

Once the vehicle 10 needs to be driven, the method 50 can be stopped automatically or in response to a command from the occupant through a switch or by interacting with a human machine interface, for example. When the method 50 stops, the side mirrors can adjust automatically to positions appropriate for driving the vehicle 10.

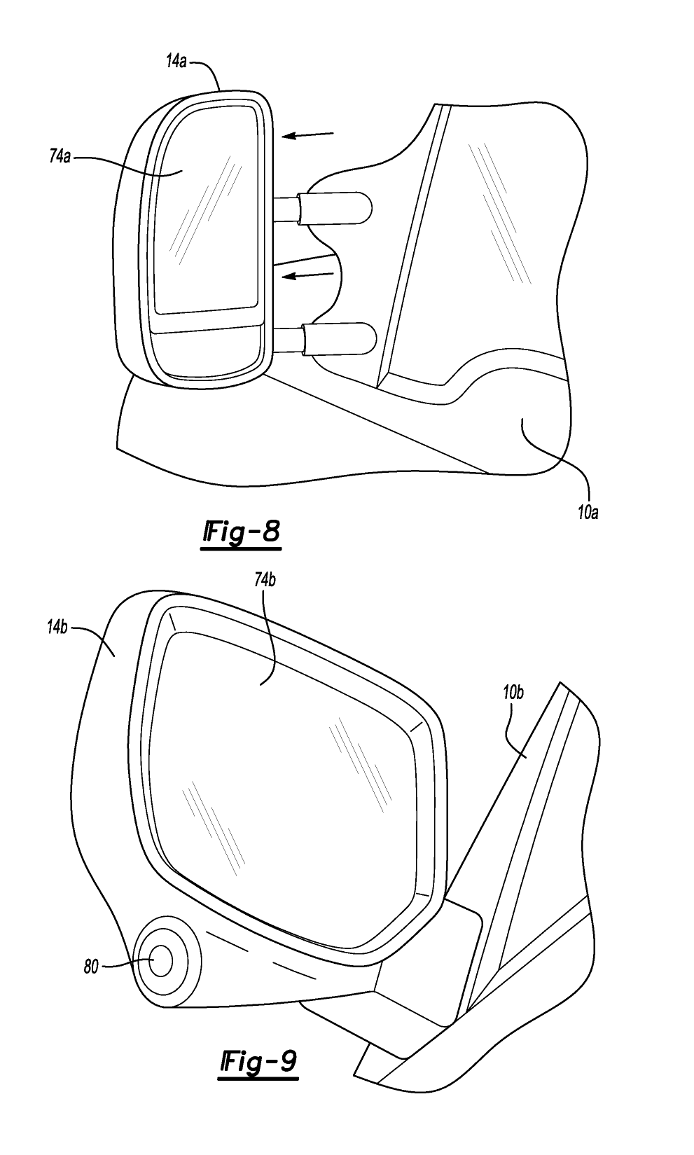

Referring to FIGS. 7 and 8, another exemplary embodiment can include a side mirror 14a of a vehicle 10a. The side mirror 14a automatically moves from a retracted position (FIG. 7) to an extended position (FIG. 8) in response to a moving object being detected behind the vehicle. The mirror of FIGS. 7 and 8 could additionally deploy to an unfolded position prior to extending, while extending, or after extending. Additionally, a reflective portion 74a of the side mirror in FIGS. 7 and 8 automatically tilts to a fully outward and a fully downward position in response to the detection of a moving object. A mirror positioning method used in connection with the side mirror 14a can include a step of extending the side mirror 14a.

Referring to FIG. 9, yet another exemplary embodiment can include a side mirror 14b of a vehicle 10b. The side mirror 14b includes a reflective portion 74b and a camera 80. The camera 80 can selectively provide an image of areas around the driver side of the vehicle 10b. These areas may not be viewable by an occupant looking at the reflective portion 74b.

A mirror positioning method used in connection with the side mirror 14b could include a step of activating the camera 80 and displaying an image captured by the camera 80 on a display within the passenger compartment of the vehicle. The camera 80 for example could display a LiDAR image on a human machine interface within the vehicle.

Features of the disclosed examples include automatically providing an occupant of a vehicle with a view of areas around the vehicle. The effectively maximized field of view can provide the occupant with information, which can enhance safety of the occupant. The method is particularly appropriate for vehicles utilized for law enforcement activities where quickly identifying objects behind the vehicle is relatively highly important.

When the vehicle is static, i.e. parked, the side mirrors need not focus on viewing objects high in the air or close to the side of the vehicle. The side mirrors can thus be positioned to maximize a visual envelope for the occupant.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A mirror positioning method, comprising:
tilting a reflective portion of at least one side mirror outward and downward in response to a detection of an object moving outside a passenger cabin of a vehicle, the tilting independent from a position of the object.

2. The mirror positioning method of claim 1, wherein the tilting occurs automatically.

3. The mirror positioning method of claim 1, wherein the tilting comprises tilting the reflective portion fully outward and fully downward.

4. The mirror positioning method of claim 1, further comprising automatically deploying the side mirror from a folded position to an unfolded position in response to the detection.

5. The mirror positioning method of claim 1, further comprising automatically extending the side mirror in response to the detection.

6. The mirror positioning method of claim 1, further comprising automatically providing an image from a camera in response to the detection.

7. The mirror positioning method of claim 6, wherein the camera is at least partially housed within the at least one side mirror.

8. The mirror positioning method of claim 1, wherein the at least one side mirror is a driver side mirror.

9. The mirror positioning method of claim 1, wherein the at least one side mirror comprises both a driver side mirror and a passenger side mirror.

10. The mirror positioning method of claim 1, wherein the vehicle is parked during the positioning.

11. The mirror positioning method of claim 1, wherein the vehicle is a law enforcement vehicle.

12. A mirror positioning method, comprising:
tilting a reflective portion of at least one side mirror fully outward and fully downward in response to a detection of an object moving outside a passenger cabin of a vehicle.

13. The method of claim 12, wherein the tilting is independent from a position of the object.

14. A mirror positioning assembly, comprising:
a surveillance controller; and
a side mirror with a reflective portion configured to automatically tilt outward and downward in response to a command from the surveillance controller, the command issued in response to a detection of an object moving outside a passenger cabin of a vehicle, the tilting independent from a position of the object.

15. The mirror positioning assembly of claim 14, wherein the side mirror is a driver side mirror.

16. The mirror positioning assembly of claim 14, wherein the side mirror moves to a fully outward and fully downward position in response to the command.

17. The mirror positioning assembly of claim 14, further comprising a sensor configured to detect the object.

18. The mirror positioning assembly of claim 17, wherein the sensor comprises a camera.

19. The mirror positioning assembly of claim 17, wherein the sensor comprises a radar sensor.
